(19) United States
(12) Patent Application Publication
(10) Pub. No.: US 2026/0340478 A1
(43) Pub. Date: Oct. 29, 2026

(54) LEARNING SYSTEM, DATA SELECTION APPARATUS, LEARNING METHOD, DATA SELECTION METHOD, AND NON-TRANSITORY COMPUTER READABLE MEDIUM

(71) Applicant: NEC Corporation, Minato-ku, Tokyo (JP)

(72) Inventor: Yoshiaki NISHIKAWA, Tokyo (JP)

(73) Assignee: NEC Corporation, Minato-ku, Tokyo (JP)

(21) Appl. No.: 19/122,309

(22) PCT Filed: Nov. 7, 2022
(86) PCT No.: PCT/JP2022/041322

§ 371 Date: Apr. 18, 2025

(51) Int. Cl. G06N 20/00; G06T 11/10; H04W 16/22

(52) U.S. Cl. CPC G06N 20/00; G06T 11/10; H04W 16/22

(57) ABSTRACT

A learning system includes: a simulation unit configured to generate a plurality of attenuation simulation maps by using a plurality of types of line-of-sight determination accuracy related to a line-of-sight determination result in a simulation environment; a learning unit configured to generate a learning model that updates a shielding region in the attenuation simulation map for each type of the line-of-sight determination accuracy; a generation unit configured to generate an attenuation map by using a line-of-sight determination result in an observation region; an update unit configured to input the attenuation map to each of the learning models and update a shielding region in the attenuation map; and a selection unit configured to select one attenuation map from among a plurality of the attenuation maps with the updated shielding regions, based on a variation result of the shielding regions in the observation region before and after the update.

### TECHNICAL FIELD

The present disclosure relates to a learning system, a data selection apparatus, a learning method, a data selection method, and a non-transitory computer readable medium.

### BACKGROUND ART

In recent years, it is required to develop a wireless network environment at a manufacturing site such as a factory and digitize business at the manufacturing site to improve efficiency of the business. On the other hand, it is known that industrial machines, products, and the like are densely present in the factory, and a propagation environment of radio waves in the factory is different from a propagation environment of radio waves in the outdoors or a general business space. Therefore, it is necessary to appropriately grasp the propagation environment of the radio waves in the factory and then design and construct a wireless network in the factory.

Here, there is wireless tomography as a method of estimating a spatial distribution of signal attenuation in a three-dimensional space in a factory or the like. The wireless tomography may be referred to as radio tomographic imaging (RTI). In the wireless tomography, a wireless signal is emitted in the three-dimensional space, and an observation result thereof is used. At this time, the spatial distribution of the signal attenuation is referred to as an attenuation map.

Non Patent Literature 1 discloses estimating an attenuation map of a signal in a three-dimensional space by executing the wireless tomography using line of sight (LOS)/non line of sight (NLOS) identification. The LOS/NLOS identification is to identify whether or not there is a line of sight between a transmission apparatus and a reception apparatus that perform communication in the three-dimensional space. A state where there is a line of sight is referred to as the LOS, and a state where there is no line of sight is referred to as the NLOS.

Here, in an actual factory or the like, in a case where a position or a structure of a shielding object that shields propagation of radio waves is estimated using the method disclosed in Non Patent Literature 1, a reflected wave or the like generated in the factory may become noise, and estimation accuracy may be deteriorated. Therefore, it has been studied to reproduce the propagation of the radio waves in an environment of the actual factory by simulation, and to generate an attenuation map in the factory by applying the method disclosed in Non Patent Literature 1 to a simulation result. More specifically, it has been studied to generate a learning model for generating the attenuation map from the simulation result.

### CITATION LIST

### Non Patent Literature

Non Patent Literature 1: Takahiro Matsuda and four others, “Binary Radio Tomographic Imaging Based on LOS/NLOS Identification”, The Institute of Electronics, Information and Communication Engineers, 2022-09

### SUMMARY OF INVENTION

### Technical Problem

However, LOS/NLOS determination accuracy in a simulation environment is often different from LOS/NLOS determination accuracy in an environment of an actual factory. Specifically, in the simulation environment, since a position and a structure of a shielding object can be clearly determined, the LOS/NLOS determination accuracy becomes extremely high. On the other hand, in a case where the position of the shielding object or the structure of the shielding object having a high attenuation degree in the environment of the actual factory is estimated, the position and the structure of the shielding object cannot be determined in advance. Therefore, the LOS/NLOS determination accuracy in the environment of the actual factory deteriorates compared with that in the simulation environment. Therefore, for example, there is a problem that desired estimation accuracy cannot be obtained even if a learning model generated for estimation of an attenuation map in the simulation environment is used for estimation of an attenuation map in the environment of the actual factory.

In view of the above-described problem, an object of the present disclosure is to provide a learning system, a data selection apparatus, a learning method, a data selection method, and a non-transitory computer readable medium capable of improving estimation accuracy of an attenuation map in an environment such as an actual factory.

### Solution to Problem

A learning system according to a first aspect of the present disclosure includes: a simulation unit configured to generate a plurality of attenuation simulation maps indicating a spatial distribution of signal attenuation by using a plurality of types of line-of-sight determination accuracy related to a line-of-sight determination result in a simulation environment; a learning unit configured to generate a learning model that updates a shielding region in the attenuation simulation map in association with each type of the line-of-sight determination accuracy; a generation unit configured to generate an attenuation map indicating a spatial distribution of signal attenuation by using a line-of-sight determination result; an update unit configured to input the attenuation map to each of the learning models and to update a shielding region in the attenuation map; and a selection unit configured to select one attenuation map from among a plurality of the attenuation maps with the updated shielding regions, on the basis of a variation result of the shielding regions in the observation region before and after the update.

A data selection apparatus according to a second aspect of the present disclosure includes: a generation unit configured to generate an attenuation map indicating a spatial distribution of signal attenuation by using a line-of-sight determination result in an observation region; an update unit configured to input the attenuation map to a learning model that is generated in association with each type of line-of-sight determination accuracy and updates a shielding region in an attenuation simulation map, a plurality of the attenuation simulation maps indicating a spatial distribution of signal attenuation being generated by using a plurality of types of the line-of-sight determination accuracy related to a line-of-sight determination result in a simulation environment, and configured to update a shielding region in the attenuation map; and a selection unit configured to select one attenuation map from among a plurality of the attenuation maps with the updated shielding regions, on the basis of a variation result of the shielding regions in the observation region before and after the update.

A learning method according to a third aspect of the present disclosure includes: generating a plurality of attenuation simulation maps indicating a spatial distribution of signal attenuation by using a plurality of types of line-of-sight determination accuracy related to a line-of-sight determination result in a simulation environment; generating a learning model that updates a shielding region in the attenuation simulation map in association with each type of the line-of-sight determination accuracy; generating an attenuation map indicating a spatial distribution of signal attenuation by using a line-of-sight determination result in an observation region; inputting the attenuation map to each of the learning models and updating a shielding region in the attenuation map; and selecting one attenuation map from among a plurality of the attenuation maps with the updated shielding regions, on the basis of a variation result of the shielding regions in the observation region before and after the update.

A data selection method according to a fourth aspect of the present disclosure includes: generating an attenuation map indicating a spatial distribution of signal attenuation by using a line-of-sight determination result in an observation region; inputting the attenuation map to a learning model that is generated in association with each type of line-of-sight determination accuracy and updates a shielding region in an attenuation simulation map, a plurality of the attenuation simulation maps indicating a spatial distribution of signal attenuation being generated by using a plurality of types of the line-of-sight determination accuracy related to a line-of-sight determination result in a simulation environment, and updating a shielding region in the attenuation simulation map; and selecting one attenuation map from among a plurality of the attenuation maps with the updated shielding regions, on the basis of a variation result of the shielding regions in the observation region before and after the update.

A program according to a fifth aspect of the present disclosure causes a computer to execute: generating a plurality of attenuation simulation maps indicating a spatial distribution of signal attenuation by using a plurality of types of line-of-sight determination accuracy related to a line-of-sight determination result in a simulation environment; generating a learning model that updates a shielding region in the attenuation simulation map in association with each type of the line-of-sight determination accuracy; generating an attenuation map indicating a spatial distribution of signal attenuation by using a line-of-sight determination result in an observation region; inputting the attenuation map to each of the learning models and updating a shielding region in the attenuation map; and selecting one attenuation map from among a plurality of the attenuation maps with the updated shielding regions, on the basis of a variation result of the shielding regions in the observation region before and after the update.

### Advantageous Effects of Invention

According to the present disclosure, it is possible to provide a learning system, a data selection apparatus, a learning method, a data selection method, and a non-transitory computer readable medium capable of improving estimation accuracy of an attenuation map in an environment such as an actual factory.

### BRIEF DESCRIPTION OF DRAWINGS

FIG. 1 is a configuration diagram of a learning system according to a first example embodiment.

FIG. 2 is a diagram illustrating a flow of learning processing according to the first example embodiment.

FIG. 3 is a configuration diagram of a learning system according to a second example embodiment.

FIG. 4 is a diagram illustrating a flow of processing of a learning phase according to the second example embodiment.

FIG. 5 is a diagram illustrating an attenuation map according to the second example embodiment.

FIG. 6 is a diagram illustrating the attenuation map according to the second example embodiment.

FIG. 7 is a diagram illustrating the attenuation map according to the second example embodiment.

FIG. 8 is a diagram illustrating a flow of processing of an inference phase according to the second example embodiment.

FIG. 9 is a diagram for describing measurement of a wireless propagation environment in an observation region according to the second example embodiment.

FIG. 10 is a configuration diagram of a learning apparatus or a data selection apparatus according to each example embodiment.

### EXAMPLE EMBODIMENT

### First Example Embodiment

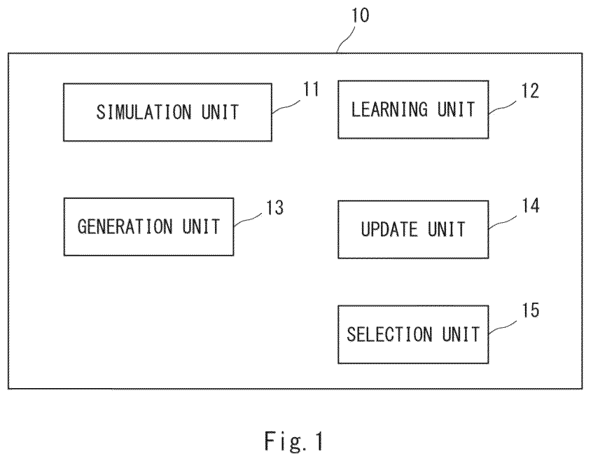

Hereinafter, example embodiments of the present invention will be described with reference to the drawings. A learning system 10 in FIG. 1 includes a simulation unit 11, a learning unit 12, a generation unit 13, an update unit 14, and a selection unit 15. The respective functional blocks constituting the learning system 10 may be included in one apparatus or may be distributedly disposed in two or more apparatuses. The apparatus constituting the learning system 10 may be a computer apparatus operated by a processor executing a program stored in a memory. The computer apparatus may be, for example, a communication apparatus or a control apparatus, or may be a server apparatus.

The simulation unit 11, the learning unit 12, the generation unit 13, the update unit 14, and the selection unit 15 may be software or modules whose processing is executed by a processor executing a program stored in a memory. Alternatively, the simulation unit 11, the learning unit 12, the generation unit 13, the update unit 14, and the selection unit 15 may be hardware such as a circuit or a chip. The processing executed in each functional block may be executed by one processor executing a program stored in a memory, or may be distributedly executed in two or more processors.

The simulation unit 11 generates a plurality of attenuation simulation maps indicating a spatial distribution of signal attenuation by using a plurality of types of line-of-sight determination accuracy related to a line-of-sight determination result in a simulation environment. The simulation environment may be, for example, an environment in which a space similar to an actual observation region such as a factory is reproduced in a computer apparatus. In addition, the line-of-sight determination result may be determined with reference to a simulation observation position in the simulation environment, or may be determined using reception power, a reception direction, and a transmission source direction. The simulation observation position may be an optional position in the simulation environment.

The line-of-sight determination result is, for example, a determination result as to whether a measurement position in the simulation environment can be seen or cannot be seen with reference to the simulation observation position. For example, the simulation observation position may be a position simulating a position of a transmission apparatus for a signal in the observation region, and the measurement position may be a position simulating a position of a reception apparatus for a signal in the observation region. Alternatively, the simulation observation position may be a position simulating the position of the reception apparatus for the signal in the observation region, and the measurement position may be a position simulating the position of the transmission apparatus for the signal in the observation region. The determination result as to whether the measurement position in the simulation environment can be seen or cannot be seen may be referred to as, for example, LOS/NLOS determination.

The LOS/NLOS determination with reference to the simulation observation position may be performed on the basis of a position of a shielding object that is disposed in the simulation environment and shields propagation of a signal. For example, in a case where the shielding object is disposed on a straight line connecting the simulation observation position and the measurement position, it may be determined as NLOS, and in a case where no shielding object is disposed on the line, it may be determined as LOS. In addition, the LOS/NLOS determination may be performed on the basis of whether or not the shielding object is disposed on a region defined as a propagation path of radio waves between the simulation observation position and the measurement position, not limited to the straight line connecting the simulation observation position and the measurement position.

Moreover, in the LOS/NLOS determination, a material or the like of the shielding object disposed in the simulation environment may be considered. For example, in a case where the material of the shielding object disposed on the straight line connecting the simulation observation position and the measurement position is metal, it may be determined as NLOS, and in a case where the shielding object disposed on the line is a substance that transmits radio waves, it may be determined as LOS.

Moreover, in the LOS/NLOS determination, in a case where a difference between a distance in the straight line between the simulation observation position and the measurement position and a path of a reflected wave is extremely small, it may be determined as LOS even if the shielding object is disposed on the straight line connecting the simulation observation position and the measurement position. It may be determined as NLOS in a case where the difference between the distance in the straight line between the simulation observation position and the measurement position and the path of the reflected wave is greater than a predetermined value and the shielding object is disposed on the straight line connecting the simulation observation position and the measurement position. The difference between the distance in the straight line between the simulation observation position and the measurement position and the path of the reflected wave for determining as LOS or NLOS may be determined in advance.

The line-of-sight determination accuracy may be a value indicating accuracy of the LOS/NLOS determination. The accuracy of the LOS/NLOS determination may be, for example, a value indicating a ratio at which it is erroneously determined as NLOS while it is originally necessary to be determined as LOS, or a ratio at which it is erroneously determined as LOS while it is originally necessary to be determined as NLOS. In the simulation environment, it is possible to set the plurality of types of line-of-sight determination accuracy. For example, the determination accuracy in a case where the LOS/NLOS determination is not erroneous may be set to 100%, and the determination accuracy may be deteriorated as the ratio of erroneous LOS/NLOS determination increases.

The attenuation simulation map may be image data indicating an attenuation degree of a wireless signal or an attenuation amount of the wireless signal by a difference in color. The difference in color may be indicated by a value set to each of a plurality of pixels constituting the image data. For example, an 8-bit value of each of red (R), green (G), and blue (B) may be set to one pixel. Alternatively, in a case where a grayscale color set to one pixel is indicated by an 8-bit value, a portion having the highest attenuation degree may be set to 255 indicating white, and a portion having the lowest attenuation degree may be set to 0 indicating black. The portion having the highest attenuation degree may be rephrased as a portion that does not transmit radio waves. The portion having the lowest attenuation degree may be rephrased as a portion that transmits radio waves without attenuating the radio waves.

The attenuation degree of the wireless signal may be, for example, a value indicating a ratio of intensity of a signal received at the measurement position to intensity of the signal transmitted from the simulation observation position. That is, the greater the attenuation amount, the greater the attenuation degree. For the generation of the attenuation simulation map using the LOS/NLOS determination result, for example, the method disclosed in Non Patent Literature 1 may be used, and another method may be used.

The learning unit 12 generates a learning model that updates a shielding region in an attenuation simulation map in association with each type of line-of-sight determination accuracy. In the attenuation simulation map, it is assumed that a shielding object exists at a portion where an attenuation degree or an attenuation amount is greater than a predetermined value, and a region where the shielding object exists is set as the shielding region. The learning model may be, for example, a learning model that updates the shielding region in the attenuation simulation map on the basis of a shape or the like of the shielding object using the attenuation simulation map as an input. In a case where a plurality of types of the line-of-sight determination accuracy is used in the simulation unit 11, the attenuation simulation map is generated for a line-of-sight determination result to which each type of the line-of-sight determination accuracy is applied. That is, the line-of-sight determination accuracy and the attenuation simulation map are associated with each other. Moreover, the learning model is generated for each attenuation simulation map. With this configuration, the line-of-sight determination accuracy and the learning model are associated with each other.

For example, the learning model may update a place where the shielding object does not exist in the attenuation simulation map to a place where the shielding object exists, or may update a place where the shielding object exists to a place where the shielding object does not exist.

The generation unit 13 generates an attenuation map indicating an attenuation degree or an attenuation amount of a wireless signal by using a line-of-sight determination result in an observation region. The observation region is an actual three-dimensional space such as a factory in which a propagation environment or an attenuation state of radio waves should be measured. In addition, the line-of-sight determination result may be determined with reference to an observation position in the observation region, or may be determined using reception power, a reception direction, and a transmission source direction. In addition, an attenuation simulation map indicates a spatial distribution of signal attenuation in a simulation environment, whereas the attenuation map indicates a spatial distribution of signal attenuation in the actual three-dimensional space.

The observation position may be a position of a transmission apparatus for a signal in the observation region, and a measurement position may be a position of a reception apparatus for a signal in the observation region. Alternatively, the observation position may be the position of the reception apparatus for the signal in the observation region, and the measurement position may be the position of the transmission apparatus for the signal in the observation region. The observation position may be, for example, a position of a wireless apparatus that transmits a wireless signal in the observation region. The wireless apparatus may be, for example, a base station or an access point (AP) used as a base unit in a wireless local area network (LAN). The method of generating the attenuation map using the line-of-sight determination result may be similar to the method of generating an attenuation simulation map in the simulation unit 11, or a method different from that of the simulation unit 11 may be used.

The update unit 14 inputs an attenuation map to each learning model generated by the learning unit 12, and updates a shielding region in the attenuation map. The attenuation map with the updated shielding region is output for each learning model.

The selection unit 15 selects one attenuation map from among a plurality of the attenuation maps with updated shielding regions on the basis of a variation result of the shielding regions in an observation region before and after the update. The variation result of the shielding region may be indicated by using, for example, an area of a region updated from the shielding region to a region different from the shielding region and a region updated from a region different from the shielding region to the shielding region before and after the update. Alternatively, the variation result of the shielding region may be indicated by using the number of pixels at a portion where a variation of the shielding region occurs in image data. The variation of the shielding region in the attenuation map before and after the update can be said to be, for example, a region determined to be an erroneous region in inference of each learning model.

For example, the selection unit 15 may select, as the variation result, an attenuation map in which a difference between the shielding regions in the observation region before and after the update is minimum. Alternatively, the selection unit 15 may select, as the variation result, an attenuation map in which the difference between the shielding regions in the observation region before and after the update is maximum.

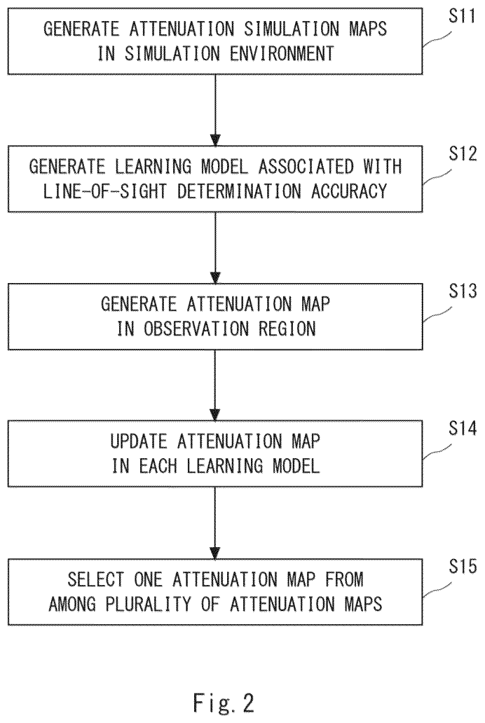

Next, a flow of learning processing executed in the learning system according to the first example embodiment will be described with reference to FIG. 2.

First, the simulation unit 11 generates a plurality of attenuation simulation maps indicating an attenuation degree of a wireless signal by using a plurality of types of line-of-sight determination accuracy related to a line-of-sight determination result with reference to a simulation observation position in a simulation environment (S11). Next, the learning unit 12 generates a learning model that updates a shielding region in the attenuation simulation map in association with each type of the line-of-sight determination accuracy (S12). Next, the generation unit 13 generates an attenuation map indicating an attenuation degree of a wireless signal by using a line-of-sight determination result with reference to an observation position in an observation region (S13).

Next, the update unit 14 inputs the attenuation map to each learning model, and updates a shielding region in the attenuation map (S14). Next, the selection unit 15 selects one attenuation map from among a plurality of the attenuation maps with the updated shielding regions on the basis of a variation result of the shielding regions in the observation region before and after the update (S15).

As described above, the learning system 10 according to the first example embodiment generates a learning model associated with each type of line-of-sight determination accuracy by using a plurality of line-of-sight determination accuracy. Moreover, the learning system 10 selects one attenuation map as an attenuation map representing a position of a shielding object in an actual observation region on the basis of a variation result of a shielding region from among attenuation maps updated using the respective learning models. With this configuration, the learning system 10 can select an optimal attenuation map by compensating for a difference between line-of-sight determination accuracy in a simulation environment and line-of-sight determination accuracy in the actual observation region.

### Second Example Embodiment

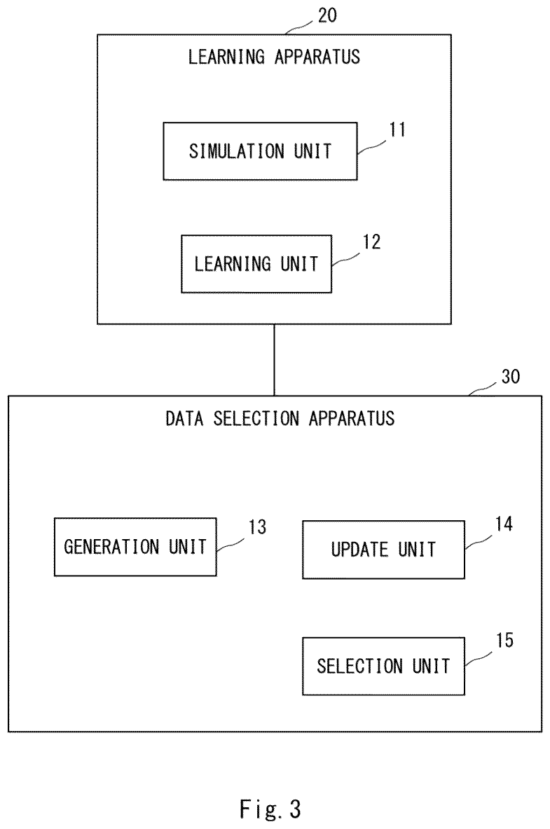

Next, a configuration example of a learning system will be described with reference to FIG. 3. The learning system in FIG. 3 includes a learning apparatus 20 and a data selection apparatus 30. The learning apparatus 20 and the data selection apparatus 30 may be computer apparatuses that operate by a processor executing a program stored in a memory.

FIG. 3 indicates that the simulation unit 11 and the learning unit 12 described with reference to FIG. 1 are disposed in the learning apparatus 20, and the generation unit 13, the update unit 14, and the selection unit 15 are disposed in the data selection apparatus 30. FIG. 3 is an example of a distributed disposition example of the simulation unit 11, the learning unit 12, the generation unit 13, the update unit 14, and the selection unit 15, and each function may have distributed disposition different from that in FIG. 3.

In FIG. 3, the learning apparatus 20 executes a learning phase for generating a learning model, and the data selection apparatus 30 executes an inference phase for applying data acquired from an actual observation region to the learning model.

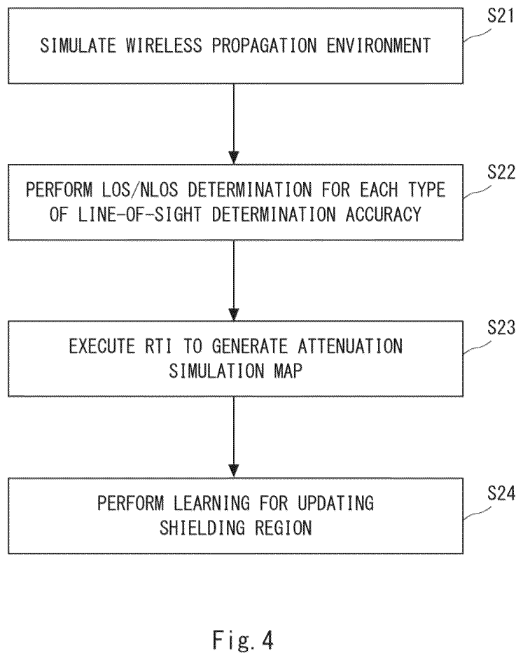

Here, a flow of processing of the learning phase executed by the learning apparatus 20 will be described with reference to FIG. 4. First, the simulation unit 11 simulates a wireless propagation environment in a simulation environment (S21). The simulation environment may be, for example, an environment simulating a closed space in a building such as a factory. In addition, in the simulation environment, disposition of a shielding object that shields propagation of a wireless signal is also simulated. For example, the simulation unit 11 generates the simulation environment with various patterns of the shielding object by changing a position of the shielding object, a material of the shielding object, a structure of the shielding object, a size of the shielding object, and the like in the simulation environment. In addition, the simulation unit 11 may generate the simulation environment with a pattern in which the shielding object moves, a pattern in which the shielding object is fixed, or a pattern in which the moving shielding object and the fixed shielding object are mixed.

Moreover, the simulation unit 11 determines, as a simulation observation position, a position of a transmission apparatus that transmits a wireless signal, set at an optional position in the simulation environment. In consideration of the position of the shielding object, the simulation unit 11 determines a value of reception power in a case where a reception apparatus receives the wireless signal transmitted from the transmission apparatus at the optional position in the simulation environment. That is, the simulation unit 11 may generate a reception power distribution in the simulation environment as the wireless propagation environment.

Next, the simulation unit 11 performs LOS/NLOS determination with reference to the simulation observation position in the simulation environment (S22). Here, the simulation unit 11 has a plurality of types of LOS/NLOS determination accuracy, and performs the LOS/NLOS determination in the simulation environment for each type of the LOS/NLOS determination accuracy.

The LOS/NLOS determination may be made on the basis of whether or not the shielding object is disposed on a straight line between the transmission apparatus and the reception apparatus, and on the basis of the material, the structure, or the like of the shielding object. That is, the LOS/NLOS determination may determine whether or not the reception apparatus can receive a direct wave transmitted from the transmission apparatus. For example, in a case where the reception apparatus can receive the direct wave from the transmission apparatus, LOS determination is made, and in a case where the reception apparatus cannot receive the direct wave from the transmission apparatus, the NLOS determination is made. Moreover, the LOS/NLOS determination may be performed in consideration of an influence of a reflected wave received by the reception apparatus. For example, a position where the value of the reception power is greater than a predetermined value may be determined as LOS, and a position where the value of the reception power is smaller than the predetermined value may be determined as NLOS.

The LOS/NLOS determination is a determination as to whether or not the reception apparatus can be seen from the simulation observation position. Therefore, in the simulation environment in which the position of the shielding object, the material of the shielding object, the structure of the shielding object, the position of the transmission apparatus, and the position of the reception apparatus are known, accuracy of the LOS/NLOS determination can be set to 100%. However, in a case where the position of the shielding object, the structure of the shielding object, and the like are estimated using the reception power distribution in an actual observation region, the value of the reception power is used. Here, in the actual observation region, the reflected wave may reach a position where the direct wave does not reach from an observation position. Therefore, since the position where the direct wave does not reach from the observation position cannot be seen from the observation position, it should be determined as NLOS. However, in a case where a wireless signal greater than the predetermined reception power is received, it may be determined as LOS. In this manner, in a case where the LOS/NLOS determination is performed using the reception power distribution of the wireless signal in the actual observation region, a position to be determined as NLOS may be determined as LOS due to the influence of the reflected wave. Therefore, in the actual observation region, the accuracy of the LOS/NLOS determination is generally not 100%.

Therefore, the simulation unit 11 may execute the LOS/NLOS determination with the plurality of types of determination accuracy by considering the influence of the reflected wave. As the plurality of types of determination accuracy, for example, values of 100% or less, such as 99%, 98%, and 90%, may be set.

The simulation unit 11 obtains an LOS/NLOS determination result for each type of the determination accuracy by executing the LOS/NLOS determination using the plurality of types of LOS/NLOS determination accuracy.

Next, the simulation unit 11 executes wireless tomography to generate an attenuation simulation map (S23). The attenuation simulation map and an attenuation map may be referred to as a spatial loss field (SLF). Executing the wireless tomography may be rephrased as executing RTI. Generating the attenuation simulation map may be rephrased as estimating the attenuation simulation map.

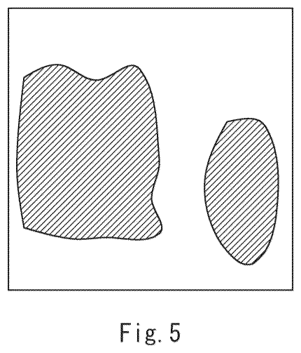

Here, an example of the attenuation simulation map generated in the simulation unit 11 will be described with reference to FIG. 5. In an attenuation simulation map in FIG. 5, shaded regions are indicated as regions where a wireless signal does not propagate due to an influence of shielding objects. A region other than the shaded region is indicated as a region where a wireless signal propagates. That is, in FIG. 5, it is estimated that the shielding objects exist in the shaded regions. In the attenuation simulation map in FIG. 5, for example, a simulation observation position may be set around a center of FIG. 5. The attenuation simulation map in FIG. 5 is illustrated using the shaded regions and the non-shaded region for ease of description. An actual attenuation simulation map is, for example, image data including a plurality of pixels, and a grayscale color may be indicated by using an 8-bit value for each pixel. In addition, in FIG. 5, a boundary between the shaded region and the other region is clearly indicated by a straight line or a curve line, but in the actual attenuation simulation map, the boundary may be indicated as a region whose color is blurred.

The simulation unit 11 generates the attenuation simulation map for each LOS/NLOS determination result having the different determination accuracy.

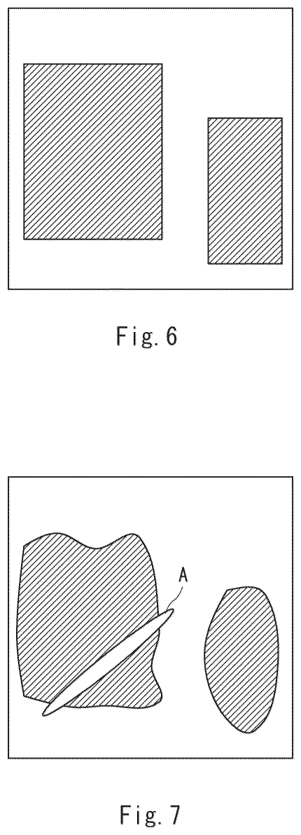

Returning to FIG. 4, the learning unit 12 performs learning for updating the shielding region for each attenuation simulation map (S24). For example, the learning unit 12 may generate a learning model that updates a region of the shielding object in the attenuation simulation map using a shape of the shielding object as teacher data or ground truth data. For example, in a case where the attenuation simulation map is input to the learning model that updates the region of the shielding object of the attenuation simulation map, the region of the shielding object may be updated so as to approach the shape of the shielding object as illustrated in FIG. 6.

In addition, as the LOS/NLOS determination accuracy deteriorates, an erroneous LOS/NLOS determination result increases. For example, as the erroneous LOS/NLOS determination result increases, a region other than the shielding region exists in the shielding region as illustrated in a region A in FIG. 7, so that a so-called state where a part of the shielding region is missing may be entered. In this manner, in a case where the attenuation simulation map generated on the basis of the determination result with low LOS/NLOS determination accuracy is updated, the learning model may be constructed so as to restore the missing state on the assumption that there is the missing state in the shielding region.

That is, the learning model for updating the attenuation simulation map generated on the basis of higher LOS/NLOS determination accuracy is a learning model that has a strong tendency to make the boundary of the shielding region a clearer boundary. Making the boundary of the shielding region a clearer boundary means removing noise existing near the boundary. In addition, the learning model for updating the attenuation simulation map generated on the basis of lower LOS/NLOS determination accuracy is a learning model that has a strong tendency to make the boundary of the shielding region a clearer boundary and restore the missing region of the shielding region. As the LOS/NLOS determination accuracy deteriorates, the learning model has the stronger tendency to restore the missing region of the shielding region.

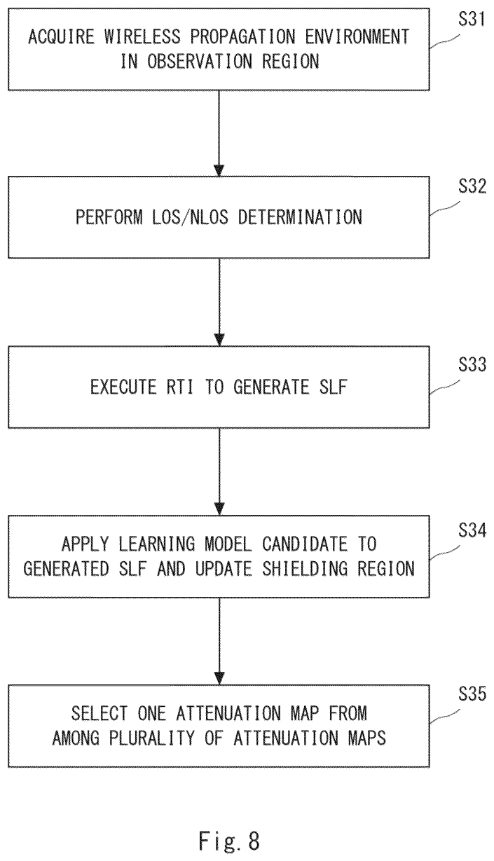

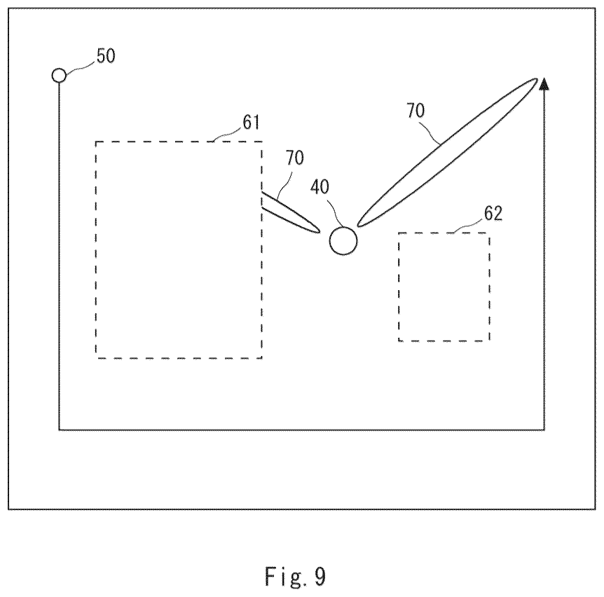

Next, a flow of processing of the inference phase in the data selection apparatus 30 will be described with reference to FIG. 8. First, the generation unit 13 acquires a wireless propagation environment in an observation region (S31). Here, measurement of the wireless propagation environment in the observation region will be described with reference to FIG. 9.

FIG. 9 indicates that, in the observation region, a wireless reception apparatus 50 during movement receives a wireless signal transmitted by a wireless transmission apparatus 40. The observation region may be, for example, a three-dimensional space having a finite region by a wall provided between an external environment and the observation region, such as in a factory or a room. The wireless transmission apparatus 40 may be, for example, a base station or an access point. The wireless reception apparatus 50 may be, for example, a smartphone terminal mounted on a vehicle, an Internet of Things (IoT) terminal, or another communication apparatus. Alternatively, a person may walk and move while holding the wireless reception apparatus 50, and receive the wireless signal from the wireless transmission apparatus 40 during the movement.

Shielding objects 61 and 62 may be, for example, objects such as metal that do not transmit radio waves. In addition, FIG. 9 illustrates a state where the wireless transmission apparatus 40 is emitting radio waves 70. The radio waves 70 indicate direct waves received by the wireless reception apparatus 50. The wireless reception apparatus 50 may receive a reflected wave together with the radio waves 70 that are the direct waves. Alternatively, the wireless reception apparatus 50 may not receive the radio waves 70 that are the direct waves, but may receive only the reflected wave.

The wireless reception apparatus 50 receives the wireless signal and measures reception power. Since the wireless reception apparatus 50 receives the wireless signal during the movement, the wireless reception apparatus 50 measures the reception power at an optional place in the observation region. The generation unit 13 acquires a measurement result in which the reception power measured by the wireless reception apparatus 50 is associated with a position where the reception power is measured. The measurement result in which the reception power measured by the wireless reception apparatus 50 is associated with the position where the reception power is measured may indicate the wireless propagation environment. The wireless propagation environment may be referred to as a reception power distribution. The wireless reception apparatus 50 may specify a current position from, for example, a movement speed, a movement time, a movement direction, and the like, or may specify the current position by using a global positioning system (GPS), a sensor, or the like. The generation unit 13 may acquire the measurement result from the wireless reception apparatus 50 via a network. Alternatively, the generation unit 13 may acquire information measured in the wireless reception apparatus 50 offline. In addition, it is assumed that the generation unit 13 holds a position of the wireless transmission apparatus 40 in advance.

Returning to FIG. 8, next, the generation unit 13 performs LOS/NLOS determination using the reception power distribution indicating the reception power measured in the wireless reception apparatus 50 and the position where the reception power is measured (S32). The generation unit 13 does not have information indicating a position of a shielding object existing in the observation region, a material of the shielding object, a structure of the shielding object, and the like. Therefore, the generation unit 13 performs the LOS/NLOS determination using the reception power distribution of the wireless signal. For example, a position where the reception power is higher than a predetermined value may be determined as LOS, and a position where the reception power is lower than the predetermined value may be determined as NLOS. Alternatively, in a case where the reception power is higher than surrounding reception power, it may be determined as LOS, and in a case where the reception power is lower than the surrounding reception power, it may be determined as NLOS. The method of the LOS/NLOS determination using the reception power distribution is not limited thereto, and various methods may be used.

Next, the generation unit 13 executes wireless tomography on an LOS/NLOS determination result to generate an attenuation map (spatial loss field (SLF)) (S33).

Next, the update unit 14 applies each learning model generated in the learning phase to the generated attenuation map to generate an attenuation map with an updated shielding region (S34). In other words, the update unit 14 inputs the generated attenuation map to each learning model, and acquires an attenuation map with the updated shielding region, which is output from each learning model.

Next, the selection unit 15 selects one attenuation map that most accurately indicates the position of the shielding object in the observation region from among a plurality of the attenuation maps with the updated shielding regions (S35). Here, attenuation map selection processing will be described.

It is desirable that the selection unit 15 selects, as the attenuation map after the update, the attenuation map updated by using a learning model associated with determination accuracy equivalent to LOS/NLOS determination accuracy in the observation region. On the other hand, the selection unit 15 cannot grasp the LOS/NLOS determination accuracy in the observation region.

Therefore, it is necessary for the selection unit 15 to estimate and select the attenuation map updated using the learning model associated with the determination accuracy equivalent to the LOS/NLOS determination accuracy in the observation region.

For example, a case will be described where it is assumed that the LOS/NLOS determination accuracy in the observation region is 90%, and the update unit 14 updates the attenuation map by using the learning model in which the determination accuracy is associated with 100%.

Since the wireless transmission apparatus 40 does not move all places in the observation region, the reception power distribution generated on the basis of a measurement result of the wireless transmission apparatus 40 includes an unmeasured region. In such a case, since the unmeasured region is treated as a region determined as NLOS, the unmeasured region is indicated as a region where the shielding object exists in the attenuation map. Here, in the learning model in which the determination accuracy is associated with 100%, a tendency of arranging a region of the shielding object including noise into a shape of the shielding object is enhanced. Therefore, there is a high possibility that a shielding region that does not match the shape of the shielding object among the regions where the shielding objects exist is updated to a region where the shielding object does not exist. Therefore, in a case where the attenuation map generated on the basis of a determination result in which the LOS/NLOS determination accuracy is 90% is updated using the learning model associated with the determination accuracy of 100%, it is estimated that the regions of the shielding objects are greatly reduced.

Here, a case will be described where the attenuation map generated on the basis of the determination result in which the LOS/NLOS determination accuracy is 90% is updated using a learning model associated with determination accuracy lower than 100%.

As the determination accuracy associated with the learning model deteriorates, a tendency to update a missing part of the shielding region to the shielding region is enhanced. Therefore, it is estimated that the regions of the shielding objects in the updated attenuation map increase as the learning model is associated with a lower value of the determination accuracy.

However, it is assumed that the learning model associated with the low value of the determination accuracy has low reliability of the LOS/NLOS determination result. Therefore, from the LOS/NLOS determination result, a value of each pixel constituting the attenuation map after the update and a value range that can be taken by the pixel (for example, 0 to 255 in 8 bits) are close to a median value. In a case where the reliability of the LOS/NLOS determination result is high, for example, it is possible to set a value away from the median value in each pixel and clearly indicate whether or not the shielding object exists. However, in a case where the reliability of the LOS/NLOS determination result is low, it is difficult to clearly indicate whether or not the shielding object exists, and a value close to the median value is set for each pixel, and whether or not the shielding object exists may become ambiguous. Therefore, it is assumed that the regions of the shielding objects in the updated attenuation map decrease as the learning model is associated with the lower value of the determination accuracy.

Therefore, in consideration of the increase in the regions of the shielding objects and the decrease in the regions of the shielding objects, the selection unit 15 selects the attenuation map on the basis of the variation in the regions of the shielding objects before and after the update. Specifically, the selection unit 15 may select the attenuation map having the highest ratio of the regions of the shielding objects after the update to the regions of the shielding objects before the update as the attenuation map updated by the learning model associated with the determination accuracy equivalent to the LOS/NLOS determination accuracy in the observation region.

Alternatively, the selection unit 15 may select the attenuation map by using a value obtained by subtracting the number of pixels indicating the region of the shielding object after the update from the number of pixels indicating the region of the shielding object before the update. In this case, the selection unit 15 may select the attenuation map having the greatest value obtained by the subtraction as the attenuation map updated by the learning model associated with the determination accuracy equivalent to the LOS/NLOS determination accuracy in the observation region.

As described above, the learning system according to the second example embodiment selects an attenuation map on the basis of a variation in shielding regions in the attenuation map updated by a learning model in a state where LOS/NLOS determination accuracy obtained from a reception power distribution in an observation region is unknown. With this configuration, the data selection apparatus 30 can select an appropriate attenuation map indicating a situation of the observation region. As a result, a user or the like using the learning system can appropriately dispose a wireless apparatus in the observation region using the attenuation map appropriately indicating the inside of the observation region.

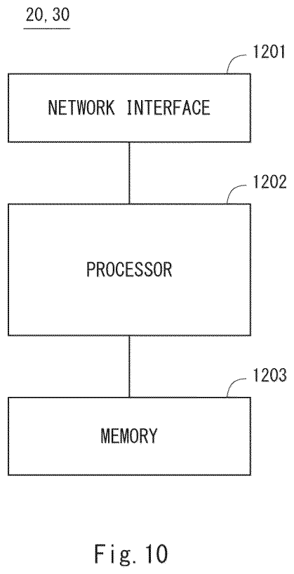

FIG. 10 is a block diagram illustrating a configuration example of the communication apparatus 10. Referring to FIG. 10, the communication apparatus 10 includes a network interface 1201, a processor 1202, and a memory 1203. The network interface 1201 is used to communicate with a network node (e.g., eNB, MME, or P-GW). The network interface 1201 may include, for example, a network interface card (NIC) conforming to IEEE 802.3 series. Here, the eNB represents an evolved node B, the MME represents a mobility management entity, and the P-GW represents a packet data network gateway. The IEEE represents Institute of Electrical and Electronics Engineers.

The processor 1202 executes the processing in the communication apparatus 10 described using the flowcharts in the above-described example embodiments, by reading software (computer programs) from the memory 1203 and executing the software. The processor 1202 may be, for example, a microprocessor, an MPU, or a CPU. The processor 1202 may include a plurality of processors.

The memory 1203 includes a combination of a volatile memory and a nonvolatile memory. The memory 1203 may include a storage disposed away from the processor 1202. In this case, the processor 1202 may access the memory 1203 via an input/output (I/O) interface (not illustrated).

In the example in FIG. 10, the memory 1203 is used to store a group of software modules. The processor 1202 can perform the processing in the communication apparatus 10 described in the above-described example embodiments, by reading the group of the software modules from the memory 1203 and executing the software module group.

As described with reference to FIG. 10, each of the processors included in the communication apparatus 10 in the above-described example embodiments executes one or a plurality of programs including a command group for causing a computer to perform an algorithm described with reference to the drawings.

In the above-described example, the program may be stored using various types of non-transitory computer readable media and supplied to a computer. The non-transitory computer readable media include various types of tangible storage media. Examples of the non-transitory computer readable medium include a magnetic storage medium (for example, a flexible disk, a magnetic tape, or a hard disk drive), an optical magnetic storage medium (for example, a magneto-optical disk), a compact disc-read only memory (CD-ROM), a CD-R, a CD-R/W, and a semiconductor memory (for example, a mask ROM, a programmable ROM (PROM), an erasable PROM (EPROM), a flash ROM, or a random access memory (RAM). In addition, the program may be supplied to the computer by various types of transitory computer readable media. Examples of transitory computer readable media include electrical signals, optical signals, and electromagnetic waves. The transitory computer readable media can supply the programs to the computer via a wired communication path such as an electric wire and an optical fiber or a wireless communication path.

Note that the present disclosure is not limited to the above-described example embodiments, and can be appropriately modified without departing from the scope.

Some or all of the above-described example embodiments may be described as in the following Supplementary Notes, but are not limited to the following Supplementary Notes.

### Supplementary Note 1

A learning system including:
a simulation unit configured to generate a plurality of attenuation simulation maps indicating a spatial distribution of signal attenuation by using a plurality of types of line-of-sight determination accuracy related to a line-of-sight determination result in a simulation environment;
a learning unit configured to generate a learning model that updates a shielding region in the attenuation simulation map in association with each type of the line-of-sight determination accuracy;
a generation unit configured to generate an attenuation map indicating a spatial distribution of signal attenuation by using a line-of-sight determination result in an observation region;
an update unit configured to input the attenuation map to each of the learning models and to update a shielding region in the attenuation map; and
a selection unit configured to select one attenuation map from among a plurality of the attenuation maps with the updated shielding regions, on the basis of a variation result of the shielding regions in the observation region before and after the update.

### Supplementary Note 2

The learning system according to Supplementary Note 1, in which
the generation unit generates the attenuation map as image data, and
the selection unit selects one attenuation map from among the plurality of attenuation maps with the updated shielding regions, on the basis of a variation result of the number of pixels constituting the shielding region in the image data.

### Supplementary Note 3

The learning system according to Supplementary Note 2, in which the selection unit selects one attenuation map from among the plurality of attenuation maps with the updated shielding regions, on the basis of a ratio of the number of pixels constituting the shielding region in the image data after the update to the number of pixels constituting the shielding region in the image data before the update.

### Supplementary Note 4

The learning system according to Supplementary Note 2 or 3, in which the selection unit selects the attenuation map in which a ratio of the number of pixels constituting the shielding region in the image data after the update to the number of pixels constituting the shielding region in the image data before the update is maximized from among the plurality of attenuation maps with the updated shielding regions.

### Supplementary Note 5

The learning system according to Supplementary Note 2, in which the selection unit selects one attenuation map from among the plurality of attenuation maps with the updated shielding regions, on the basis of a difference between the number of pixels constituting the shielding region in the image data before the update and the number of pixels constituting the shielding region in the image data after the update.

### Supplementary Note 6

The learning system according to Supplementary Note 5, in which the selection unit selects the attenuation map in which the difference between the number of pixels constituting the shielding region in the image data before the update and the number of pixels constituting the shielding region in the image data after the update is minimized from among the plurality of attenuation maps with the updated shielding regions.

### Supplementary Note 7

A data selection apparatus including:
a generation unit configured to generate an attenuation map indicating a spatial distribution of signal attenuation by using a line-of-sight determination result in an observation region;
an update unit configured to input the attenuation map to a learning model that is generated in association with each type of line-of-sight determination accuracy and updates a shielding region in an attenuation simulation map, a plurality of the attenuation simulation maps indicating a spatial distribution of signal attenuation being generated by using a plurality of types of the line-of-sight determination accuracy related to a line-of-sight determination result in a simulation environment, and configured to update a shielding region in the attenuation map; and
a selection unit configured to select one attenuation map from among a plurality of the attenuation maps with the updated shielding regions, on the basis of a variation result of the shielding regions in the observation region before and after the update.

### Supplementary Note 8

The data selection apparatus according to Supplementary Note 7, in which
the generation unit generates the attenuation map as image data, and
the selection unit selects one attenuation map from among the plurality of attenuation maps with the updated shielding regions, on the basis of a variation result of the number of pixels constituting the shielding region in the image data.

### Supplementary Note 9

A learning method including:
generating a plurality of attenuation simulation maps indicating a spatial distribution of signal attenuation by using a plurality of types of line-of-sight determination accuracy related to a line-of-sight determination result in a simulation environment;
generating a learning model that updates a shielding region in the attenuation simulation map in association with each type of the line-of-sight determination accuracy;
generating an attenuation map indicating a spatial distribution of signal attenuation by using a line-of-sight determination result in an observation region;
inputting the attenuation map to each of the learning models and updating a shielding region in the attenuation map; and
selecting one attenuation map from among a plurality of the attenuation maps with the updated shielding regions, on the basis of a variation result of the shielding regions in the observation region before and after the update.

### Supplementary Note 10

A data selection method including:
generating an attenuation map indicating a spatial distribution of signal attenuation by using a line-of-sight determination result in an observation region;
inputting the attenuation map to a learning model that is generated in association with each type of line-of-sight determination accuracy and updates a shielding region in an attenuation simulation map, a plurality of the attenuation simulation maps indicating a spatial distribution of signal attenuation being generated by using a plurality of types of the line-of-sight determination accuracy related to a line-of-sight determination result in a simulation environment, and updating a shielding region in the attenuation map; and
selecting one attenuation map from among a plurality of the attenuation maps with the updated shielding regions, on the basis of a variation result of the shielding regions in the observation region before and after the update.

### Supplementary Note 11

A non-transitory computer readable medium storing a program for causing a computer to execute:
generating a plurality of attenuation simulation maps indicating a spatial distribution of signal attenuation by using a plurality of types of line-of-sight determination accuracy related to a line-of-sight determination result in a simulation environment;
generating a learning model that updates a shielding region in the attenuation simulation map in association with each type of the line-of-sight determination accuracy;
generating an attenuation map indicating a spatial distribution of signal attenuation by using a line-of-sight determination result in an observation region;
inputting the attenuation map to each of the learning models and updating a shielding region in the attenuation map; and
selecting one attenuation map from among a plurality of the attenuation maps with the updated shielding regions, on the basis of a variation result of the shielding regions in the observation region before and after the update.

### Supplementary Note 12

A non-transitory computer readable medium storing a program for causing a computer to execute:
generating an attenuation map indicating a spatial distribution of signal attenuation by using a line-of-sight determination result in an observation region;
inputting the attenuation map to a learning model that is generated in association with each type of line-of-sight determination accuracy and updates a shielding region in an attenuation simulation map, a plurality of the attenuation simulation maps indicating a spatial distribution of signal attenuation being generated by using a plurality of types of the line-of-sight determination accuracy related to a line-of-sight determination result in a simulation environment, and updating a shielding region in the attenuation map; and
selecting one attenuation map from among a plurality of the attenuation maps with the updated shielding regions, on the basis of a variation result of the shielding regions in the observation region before and after the update.

### REFERENCE SIGNS LIST

10 LEARNING SYSTEM
11 SIMULATION UNIT
12 LEARNING UNIT
13 GENERATION UNIT
14 UPDATE UNIT
15 SELECTION UNIT
20 LEARNING APPARATUS
30 DATA SELECTION APPARATUS
40 WIRELESS TRANSMISSION APPARATUS
50 WIRELESS RECEPTION APPARATUS
61 SHIELDING OBJECT
62 SHIELDING OBJECT
70 RADIO WAVE

What is claimed is:

1. A learning system comprising:
at least one memory storing instructions; and
at least one processor configured to execute the instructions to,
generate a plurality of attenuation simulation maps indicating a spatial distribution of signal attenuation by using a plurality of types of line-of-sight determination accuracy related to a line-of-sight determination result in a simulation environment;
generate a learning model that updates a shielding region in the attenuation simulation map in association with each type of the line-of-sight determination accuracy;
generation generate an attenuation map indicating a spatial distribution of signal attenuation by using a line-of-sight determination result in an observation region;
input the attenuation map to each of the learning models and updating a shielding region in the attenuation map; and
selection select one attenuation map from among a plurality of the attenuation maps with the updated shielding regions, on the basis of a variation result of the shielding regions in the observation region before and after the update.

2. The learning system according to claim 1, wherein the at least one processor is further configured to execute the instructions to,
generate the attenuation map as image data, and
select one attenuation map from among the plurality of attenuation maps with the updated shielding regions, on the basis of a variation result of the number of pixels constituting the shielding region in the image data.

3. The learning system according to claim 2, wherein the at least one processor is further configured to execute the instructions to selects-select one attenuation map from among the plurality of attenuation maps with the updated shielding regions, on the basis of a ratio of the number of pixels constituting the shielding region in the image data after the update to the number of pixels constituting the shielding region in the image data before the update.

4. The learning system according to claim 2, wherein the at least one processor is further configured to execute the instructions to select the attenuation map in which a ratio of the number of pixels constituting the shielding region in the image data after the update to the number of pixels constituting the shielding region in the image data before the update is maximized from among the plurality of attenuation maps with the updated shielding regions.

5. The learning system according to claim 2, wherein the at least one processor is further configured to execute the instructions to select one attenuation map from among the plurality of attenuation maps with the updated shielding regions, on the basis of a difference between the number of pixels constituting the shielding region in the image data before the update and the number of pixels constituting the shielding region in the image data after the update.

6. The learning system according to claim 5, wherein the at least one processor is further configured to execute the instructions the select the attenuation map in which the difference between the number of pixels constituting the shielding region in the image data before the update and the number of pixels constituting the shielding region in the image data after the update is minimized from among the plurality of attenuation maps with the updated shielding regions.

7. A data selection apparatus comprising:
at least one memory storing instructions; and
at least one processor configured to execute the instructions to,
generate an attenuation map indicating a spatial distribution of signal attenuation by using a line-of-sight determination result in an observation region;
input the attenuation map to a learning model that is generated in association with each type of line-of-sight determination accuracy and updates a shielding region in an attenuation simulation map, a plurality of the attenuation simulation maps indicating a spatial distribution of signal attenuation being generated by using a plurality of types of the line-of-sight determination accuracy related to a line-of-sight determination result in a simulation environment, and for updating a shielding region in the attenuation map; and
select one attenuation map from among a plurality of the attenuation maps with the updated shielding regions, on the basis of a variation result of the shielding regions in the observation region before and after the update.

8. The data selection apparatus according to claim 7, wherein the at least one processor is further configured to execute the instructions to,
the attenuation map as image data, and
select one attenuation map from among the plurality of attenuation maps with the updated shielding regions, on the basis of a variation result of the number of pixels constituting the shielding region in the image data.

9. A learning method comprising:
generating a plurality of attenuation simulation maps indicating a spatial distribution of signal attenuation by using a plurality of types of line-of-sight determination accuracy related to a line-of-sight determination result in a simulation environment;
generating a learning model that updates a shielding region in the attenuation simulation map in association with each type of the line-of-sight determination accuracy;
generating an attenuation map indicating a spatial distribution of signal attenuation by using a line-of-sight determination result in an observation region;
inputting the attenuation map to each of the learning models and updating a shielding region in the attenuation map; and
selecting one attenuation map from among a plurality of the attenuation maps with the updated shielding regions, on the basis of a variation result of the shielding regions in the observation region before and after the update.

10.-12 (canceled)
